(19) United States
(12) Patent Application Publication
(10) Pub. No.: US 2003/0033421 A1
(43) Pub. Date: Feb. 13, 2003

(54) Method for ascertaining network bandwidth allocation policy associated with application port numbers

(75) Inventors: Ali Haeri, Sunnyvale, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: AMPLIFY.NET, INC.

(21) Appl. No.: 09/922,107

(22) Filed: Aug. 2, 2001

(51) Int. Cl. G06F 15/16; G06F 15/173

(52) U.S. Cl. 709/232; 709/223; 709/245

(57) ABSTRACT

A network comprises a local group of network workstations and clients that periodically need access to a wide area network like the Internet. A class-based queue traffic shaper is placed in between and enforces multiple service-level agreement policies on individual connection sessions by limiting the maximum data throughput for each connection. The class-based queue traffic shaper distinguishes amongst datapackets according to their respective source and/or destination application types. Which policy is appropriate to enforce is found by listing all standard port numbers for an application in a single port group. Policies are attached according to port group. The field of over 64K possible port numbers is thus reduced to a short list of application groups, e.g., twelve or less. When a datapacket arrives that needs to be classified according to application, its port numbers are used to index a port group table This returns an application type and a concomitant service-level agreement policy.

### BACKGROUND OF THE INVENTION

1. Field of the Invention

The invention relates generally to computer network protocols and equipment for adjusting packet-by-packet bandwidth according to the source and/or destination port numbers carried within each such packet. More specifically, the present invention relates to software program methods for reducing delays in real-time lookup and avoids needing expensive content-addressable memory (CAM).

2. Description of the Prior Art

Access bandwidth is important to Internet users. New cable, digital subscriber line (DSL), and wireless “always-on” broadband-access together are expected to eclipse dial-up Internet access by 2001. So network equipment vendors are scrambling to bring a new generation of broadband access solutions to market for their service-provider customers. These new systems support multiple high speed data, voice and streaming video Internet-protocol (IP) services, over a single access media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) packets are conventionally treated as equals, and therein lies one of the major reasons for its “log jams”. When all IP-packets have equal right-of-way over the Internet, a “first come, first serve” service arrangement results. The overall response time and quality of delivery service is promised to be on a “best effort/” basis only. Unfortunately all IP-packets are not equal, certain classes of IP-packets must be processed differently.

In the past, such traffic congestion has caused no fatal problems, only an increasing frustration from the unpredictable and sometimes gross delays. However, new applications use the Internet to send voice and streaming video IP-packets that mix-in with the data IP-packets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service levels delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

There is a very limited time available for a bandwidth classification system to classify a datapacket before the next datapacket arrives. The search routine to find which policy attaches to a particular IP-address and/or application must be finished within a finite time. As bandwidths get higher and higher, the available search times get proportionally shorter.

Bandwidth policy can be advantageously controlled according to the application sending or receiving a datapacket. Since sixteen-bit fields are used for the application port numbers in the TCP/IP datapacket headers, there are 64K possible port numbers. But realistically, bandwidth control can be limited to a limited few kinds of groups, e.g., browser, FTP, and mail protocols.

A variety of standard port numbers have fallen into common use, as listed in Table I. Very often, a particular application will use more than one standard port number.

TABLE I

| Application | Ports |
|---|---|
| Telnet | 23 |
| POP3 | 110 |
| rtelnet | 107 |
| finger | 79 |
| LDAP | 389 |
| FTP | 20, 21 |
| HTTP | 80, 8080 |
| TFTP | 69 |
| whois | 43 |
| SNMP | 161 |
| SMTP | 25 |
| NNTP | 119 |
| gopher | 70 |
| IRC | 194 |
| UUCP | 540 |

### SUMMARY OF THE PRESENT INVENTION

It is therefore an object of the present invention to provide a system and method for controlling network bandwidth at a local site according to a predetermined policy.

It is another object of the present invention to provide method of quickly and deterministically attaching a bandwidth policy to a datapacket according to its application type.

Briefly, a network embodiment of the present invention comprises a local group of network workstations and clients that periodically need access to a wide area network like the Internet. A class-based queue traffic shaper is placed in between and enforces multiple service-level agreement policies on individual connection sessions by limiting the maximum data throughput for each connection. The class-based queue traffic shaper distinguishes amongst datapackets according to their respective source and/or destination application types. Which policy is appropriate to enforce is found by listing all standard port numbers for an application in a single port group. Policies are attached according to port group. The field of over 64K possible port numbers is thus reduced to a short list of application groups, e.g., sixteen. When a datapacket arrives that needs to be classified according to application, its port numbers are used to index a port group table. This returns an application type and a concomitant service-level agreement policy. Grouping a set of port numbers into a smaller number of port groups reduces the memory required to classify the application by TCP and UDP port numbers.

An advantage of the present invention is a system and method are provided to detect and favor with increased bandwidth any packets transmitted and received by local clients and servers.

A still further advantage of the present invention is a bandwidth allocation system is provided that prioritizes packet transfers according to service-level agreement policies.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a functional block diagram of a bandwidth allocation system embodiment of the present invention with a gateway to the Internet;

FIG. 2 is a schematic diagram representing the data that flows over a computer network between a client and an HTTP-server that can be classified by port number 80;

FIG. 3 is a flowchart of a class-based queue method embodiment of the present invention that checks to see if particular datapackets can be sent through immediately or must be buffered to stay within allowed bandwidth parameters;

FIG. 4 is a flowchart of a class-based queue method embodiment of the present invention that checks to see if additional bandwidth is available;

FIG. 5 is a flowchart of a class-based queue processing method embodiment of the present invention that checks to see if particular datapackets can be sent through immediately or must be buffered to stay within allowed bandwidth parameters;

FIG. 6 is a flowchart of a method embodiment of the present invention for defining user bandwidth parameters;

FIG. 7 is a drawing that represents the plurality of user virtual pipes that can co-exist within a single physical fiber-optic cable in an embodiment of the present invention;

FIG. 8 is a functional block diagram of a class-based queue traffic shaper embodiment of the present invention similar to the one shown in FIG. 1;

FIG. 9 is a block diagram representing an embodiment of the present invention in which all possible standard port numbers are arranged into a short list of port groups, and each such group is associated with a service-level agreement policy; and

FIG. 10 represents a digital computer memory layout for a port-group table.

### DETAILED DESCRIPTION OF THE PREFERRED EMBODIMENTS

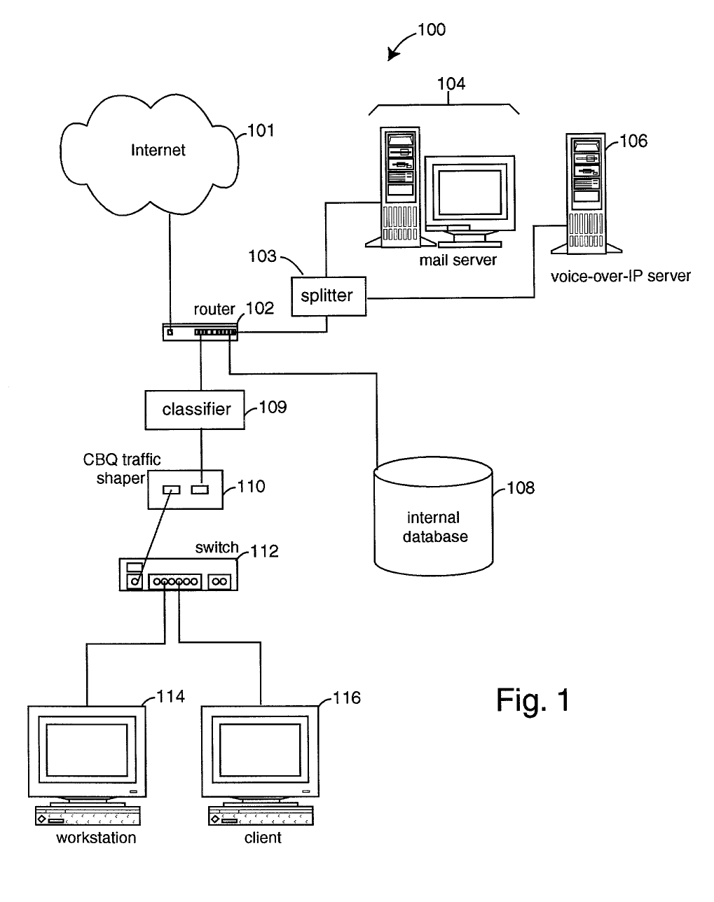

FIG. 1 illustrates a network embodiment of the present invention, and is referred to herein by the general reference numeral 100. The Internet 101 or other wide area network (WAN) is accessed through a network router 102. A bandwidth splitter 103 dynamically aggregates the demands for bandwidth presented by an e-mail server 104 and a voice-over-IP server 106 through the router 102. A local database 108 is included, e.g., to store e-mail and voice messages.

A IP-address/port-number classifier 109 monitors packet traffic passing through to the router 102, and identifies the source and destination IP_addresses and the source and destination port numbers. A class-based queue (CBQ) traffic shaper 110 dynamically controls the maximum bandwidth for each connection through a switch 112 to any workstation 114 or any client 116. A similar control is included in splitter 103. The IP-address/port-number classifier 109 sends control packets over the network to the CBQ traffic shaper 110 that tell it what packets belong to what applications. Policies are used inside the CBQ traffic shaper 110 to monitor and limit every connection involving an IP-address behind the switch 112.

The separation of the IP-address/port-number classifier 109 and CBQ traffic shaper 110 into separate stand-alone devices allows independent parallel processors to be used in what can be a very processor-intensive job. Such separation further allows the inclusion of IP-address/port-number classifier 109 as an option for which an extra price can be charged. It could also be added in later as part of a performance upgrade. The packet communication between the IP-address/port-number classifier 109 and CBQ traffic shaper 110 allows some flexibility in the physical placement of the respective units and no special control wiring in between is necessary.

The policies are defined and input by a system administrator. Internal hardware and software are used to spool and despool packet streams through at the appropriate bandwidths. In business model implementations of the present invention, subscribers are charged various fees for different levels of service, e.g., better bandwidth and delivery timeslots. For example, the workstations 114 and clients 116 could be paying customers who have bought particular levels of Internet-access service and who have on-demand service needs. One such on-demand service could be the peculiar higher bandwidth and class priority needed to support an IP-telephone call. A use-fee or monthly subscription fee could be assessed to be able to make such a call.

If the connection between the WAN 101 and the router 102 is a digital subscriber line (DSL) or other asymmetric link, the CBQ traffic shaper 110 is preferred to have a means for enforcing different policies for the same local IP-addresses transmit and receive ports.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of packet can be limited to a different connection-bandwidth than another session-connection involving a second type of packet. The SLA policies are attached to each and every local IP-address, and any connection-combinations with outside IP-addresses can be ignored.

In alternative embodiments, the CBQ traffic shaper 110 is configured so that its SLA policies are such that any policy-conflicts between local IP-address transfers are resolved with a lower-speed one of the conflicting policies taking precedence. The CBQ traffic shaper is configured so its SLA policies are dynamically attached and readjusted to allow any particular on-demand content delivery to the local IP-addresses.

The data passed back and forth between connection partners during a session must be tracked by the CBQ traffic shaper 110 if it is to have all the information needed to classify packets by application. Various identifiable patterns will appear that will signal new information. These patterns are looked for by a IP-address/port-number classifier (IP-address/port-number classifier) that monitors the datapacket exchanges. Such IP-address/port-number classifier is preferably included within the CBQ traffic shaper 110. An automatic bandwidth manager (ABM) is also included that controls the throughput bandwidth of each user by class assignment.

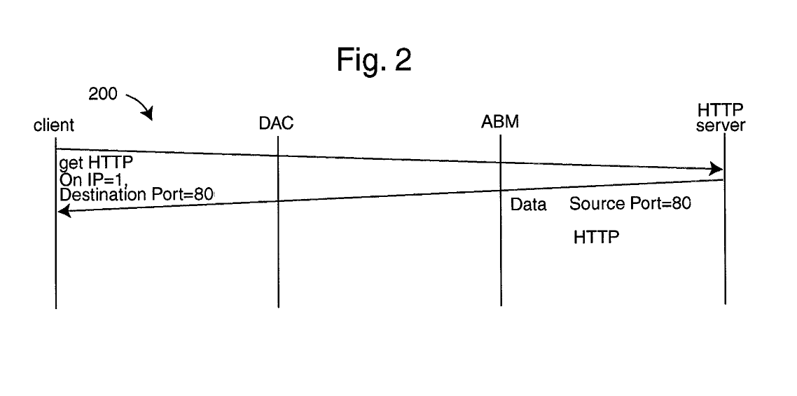

FIG. 2 represents a process 200 by which the IP-address/port-number classifier and ABM capture port information in an HTTP-type session. If any client 116 sends a “GET_msg”, e.g., on IP=1, port=8000, the port number information is added to a list of HTTP application port numbers of the ABM. This classification can lead to an SLA policy to be enforced by the bandwidth management.

Each SLA has a committed information rate (CIR) which is the minimum bandwidth guaranteed to a subscriber. If such subscriber exceeds the CIR, and there is excess bandwidth in the channel, then a maximum burst rate (MBR) can be applied. If many subscribers are in an MBR state, then a bursting priority is needed. Each subscriber's SLA policy can be set to a schedule, seven days a week, twenty-four hours a day.

Each subscriber is allocated a virtual-pipe within a real broadband access channel, pipe, or backbone. Such virtual-pipe is defined by IP/MAC addresses, and/or TCP/UDP port numbers. For example, Table I shows some common TCP-port numbers used by popular applications, and Table II shows common UDP-port numbers. Seeing traffic on these port numbers is a strong indication that the clients and servers are running the corresponding applications.

TABLE I
(TCP)

| | |
|---|---|
| FTP | 20, 21 |
| Telnet | 23 |
| SMTP | 25 |
| DNS | 53 |
| Gopher | 70 |
| WWW http | 80-84 |
| DLSW read | 2065 |
| DLSW write | 2067 |

TABLE II
(UDP)

| | |
|---|---|
| DNS | 53 |
| TFTP | 69 |
| SNMP | 161 |
| SNMPTRAP | 162 |

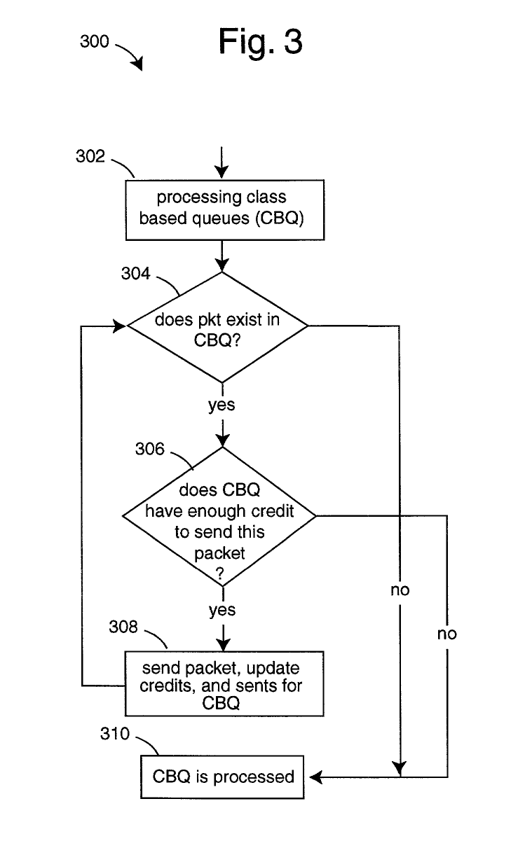

FIG. 3 illustrates a class-based queue processing method 300 that starts with a step 302. Such executes, typically, as a subroutine in the CBQ traffic shaper 110 of FIG. 1. A step 304 decides whether an incoming packet has a recognized class. If so, a step 306 checks that class currently has available bandwidth. If yes, a step 308 sends that datapacket on to its destination without detaining it in a buffer. Step 308 also deducts the bandwidth used from the class' account, and updates other statistics. Step 308 returns to step 304 to process the next datapacket. Otherwise, a step 310 simply returns program control.

In general, recognized classes of datapackets will be accelerated through the system by virtue of increased bandwidth allocation. Datapackets with unrecognized classes are given lowest priority, and are stalled in buffers whenever guaranteed bandwidths are being disbursed under contracted-for user classes.

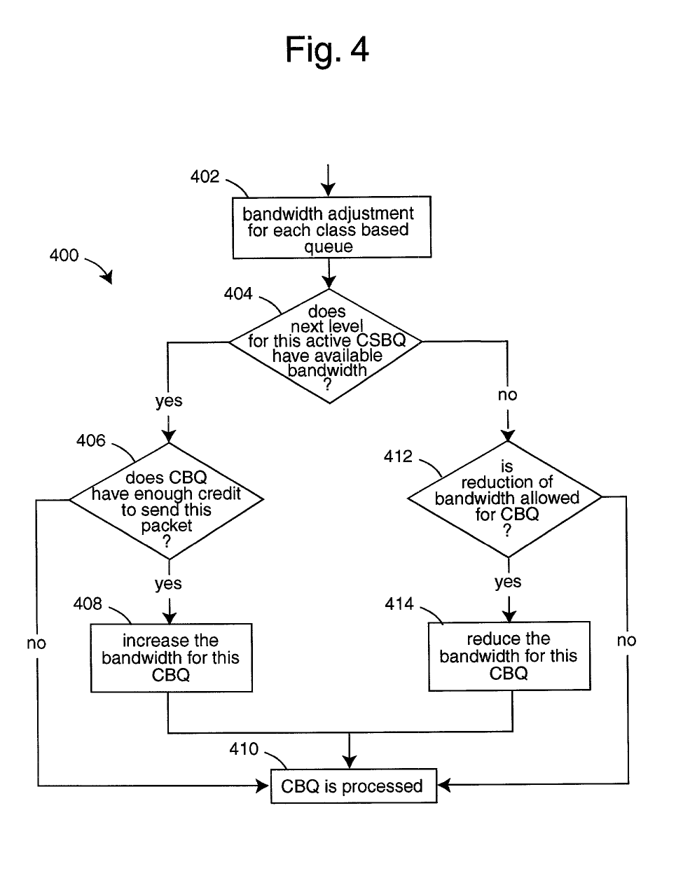

A bandwidth adjustment method 400 is represented by FIG. 4. It starts with a step 402. A step 404 decides if the next level for a current class-based queue (CBQ) has any available bandwidth that could be “borrowed”. If yes, a step 406 checks to see if the CBQ has enough “credit” to send the current datapacket. If yes, a step 408 temporarily increases the bandwidth ceiling for the CBQ and the current datapacket. A step 410 returns program control to the calling routine after the CBQ is processed. A step 412 is executed if there is no available bandwidth in the active CBQ. It checks to see if a reduction of bandwidth is allowed. If yes, a step 414 reduces the bandwidth.

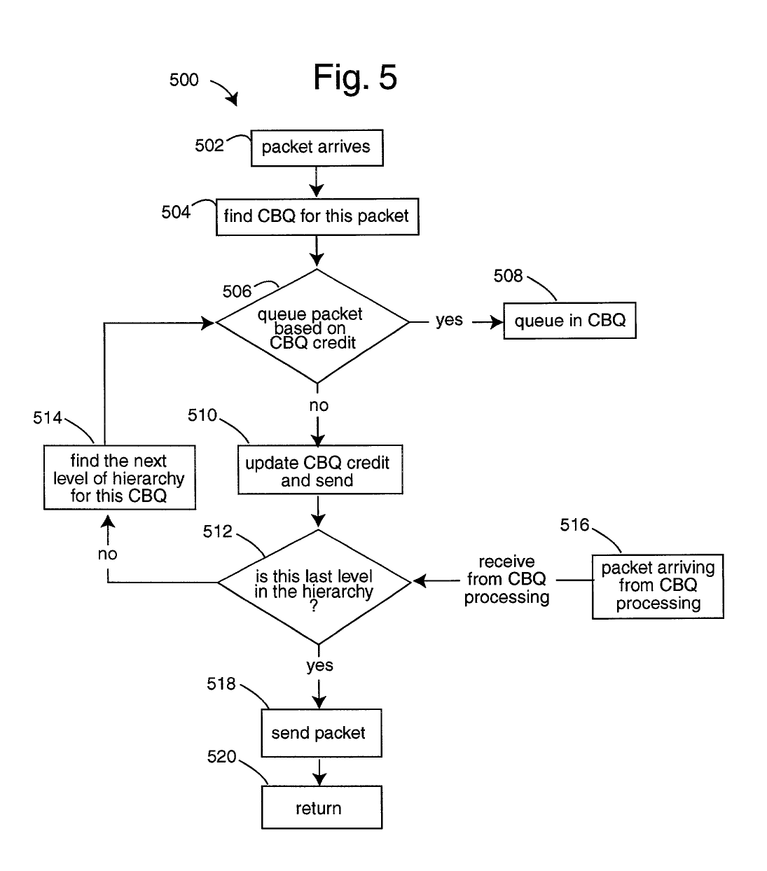

A packet process 500 is illustrated in FIG. 5 and is a method embodiment of the present invention. It begins with a step 502 when a datapacket arrives. A step 504 attempts to find a CBQ that is assigned to handle this particular class of datapacket. A step 506 checks to see if the datapacket should be queued based on CBQ credit. If yes, a step 508 queues the datapacket in an appropriate CBQ. Otherwise, a step 510 updates the CBQ credit and sends the datapacket. A step 512 checks to see if it is the last level in a hierarchy. If not, program control loops back through a step 514 that finds the next hierarchy level. A step 516 represents a return from a CBQ processing subroutine like that illustrated in FIG. 4. If the last level of the hierarchy is detected in step 512, then a step 518 sends the datapacket. A step 520 returns program control to the calling program.

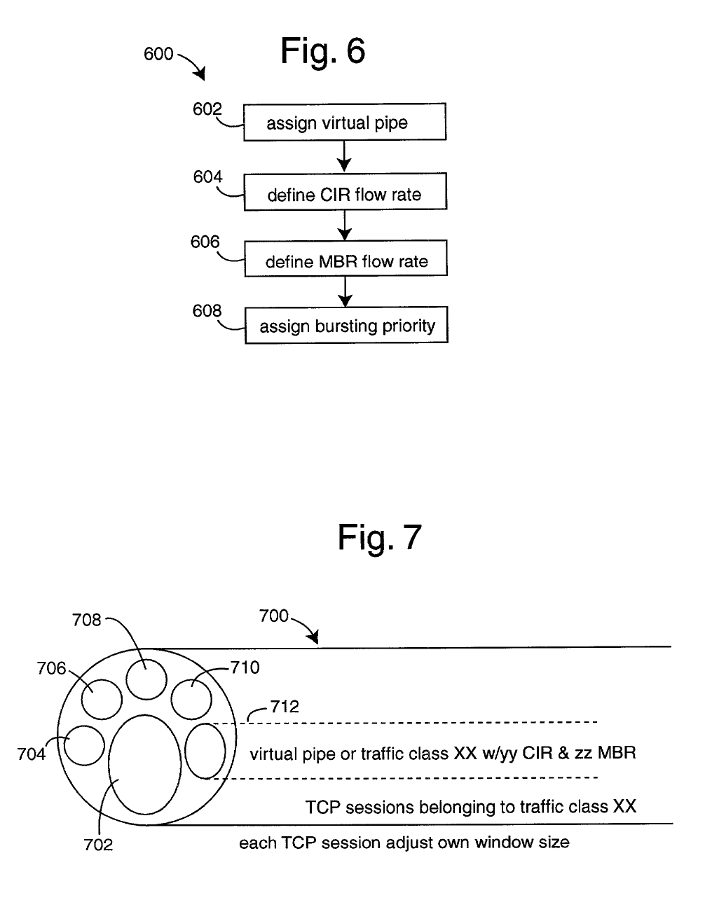

FIG. 6 represents a user setup program embodiment of the present invention, and is referred to herein by the general reference numeral 600. The program 600 includes a step 602 for assigning a virtual pipe. A step 604 defines the CIR flow rate. A step 606 defines the MBR flow rate. And, a step 608 assigns the bursting priority.

FIG. 7 represents how a physical fiberoptic cable 700 can be thought to consist of many constituent virtual pipes 702, 704, 706, 708, 710, and 712. These virtual pipes are, of course, not physically manifested as shown in the Fig. Each virtual pipe can be of different size, and each can freely vary in size dynamically over time according to user parameters, fees paid, classes of datapackets, bursts, available bandwidth, etc.

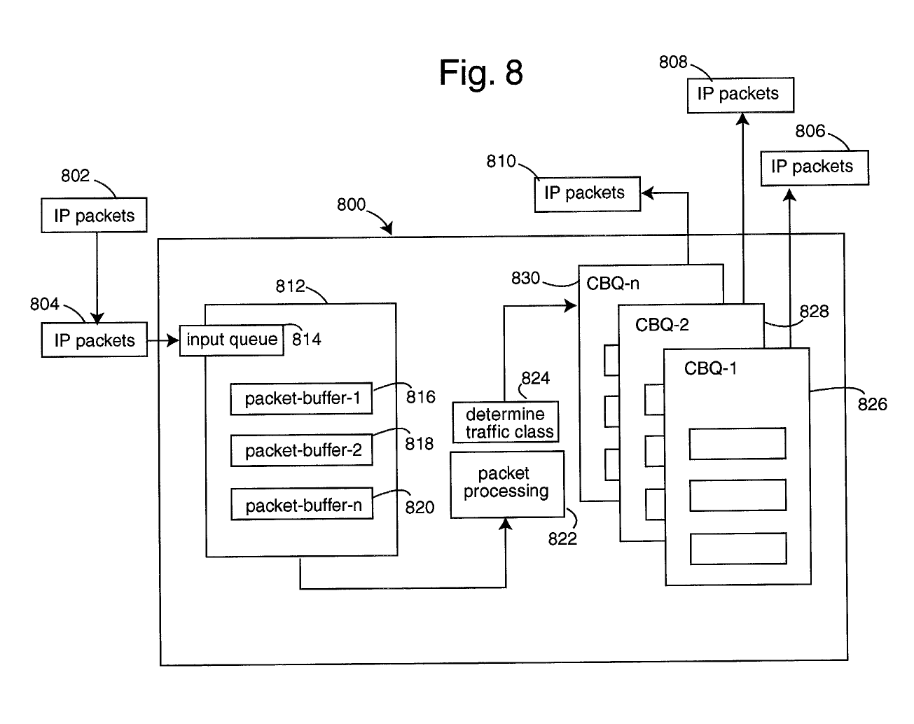

FIG. 8 illustrates a CBQ traffic shaper 800 in an embodiment of the present invention. The CBQ traffic shaper 800 receives an incoming stream of datapackets, e.g., 802 and 804. Such are typically transported with TCP/IP on a computer network like the Internet. Datapackets are output at controlled rates, e.g., as datapackets 806, 808, and 810. A typical CBQ traffic shaper 800 would have two mirror sides, one for incoming and one for outgoing for a full-duplex connection. Here in FIG. 8, only one side is shown and described to keep this disclosure simple and clear.

A IP-address/port-number classifier (IP-address/port-number classifier) 812 has an input queue 814. It has several packet buffers, e.g., as represented by packet-buffers 816, 818, and 820. Each incoming datapacket is put in a buffer to wait for classification processing. A packet processor 822 and a traffic-class determining processor 824 distribute datapackets that have been classified and those that could not be classified into appropriate class-based queues (CBQ).

A collection of CBQs constitutes an automatic bandwidth manager (ABM). Such enforces the user service level agreement policies that attach to each class. Individual CBQs are represented in FIG. 8 by CBQ 826, 828, and 830. Each CBQ can be implemented with a first-in, first-out (FIFO) register that is clocked at the maximum allowable rate (bandwidth) for the corresponding class.

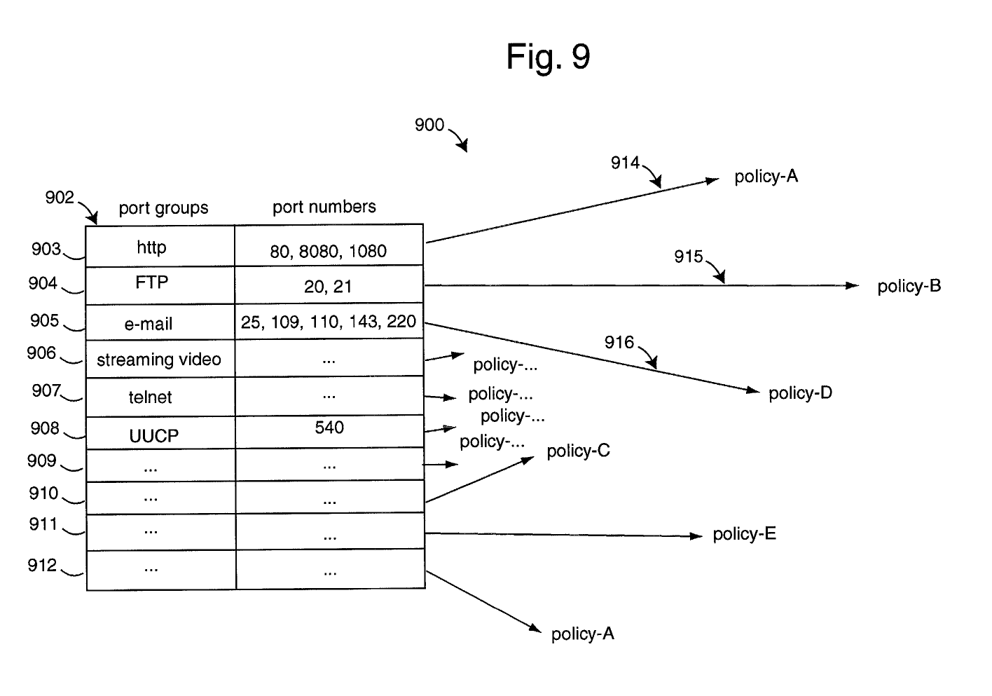

FIG. 9 represents an embodiment of the present invention which is referred to herein by the general reference numeral 900. Method embodiments of the present invention are implemented in computer software and build a table 902 of application port groups. Table II is another way of representing the application port groups and how they map to various policies. Any standard port number that is relevant to a particular policy has its port number recorded in table 902. In a typical implementation, there will be a dozen such entries, all of which are represented by port group entries 903-912.

TABLE II

| APPLICATION | TCP PORTS | POLICY |
|---|---|---|
| FTP | 20, 21 | A |
| HTTP | 80, 8080 | B |
| email | 25, 109, 110, 143, 161, 220 | C |
| NNTP | 119 | — |
| UUCP | 540 | C |

If a datapacket that needs to be classified has a destination and/or source port number that is listed in a port group entry 903-912, that port is assumed to flag that an application is running that has a special policy to be used in the class based queue. Mechanically, the table 902 provides a pointer to the appropriate policy, e.g., policy-A, policy-B, policy-C, etc. If the datapacket that needs to be classified does not have a corresponding port number entry 903-912, then a default classification and policy are preferably used.

The method related to FIG. 9 therefore uses far less memory than would otherwise be the case, and the policy fetch is much quicker. In this case, a simple two-step procedure.

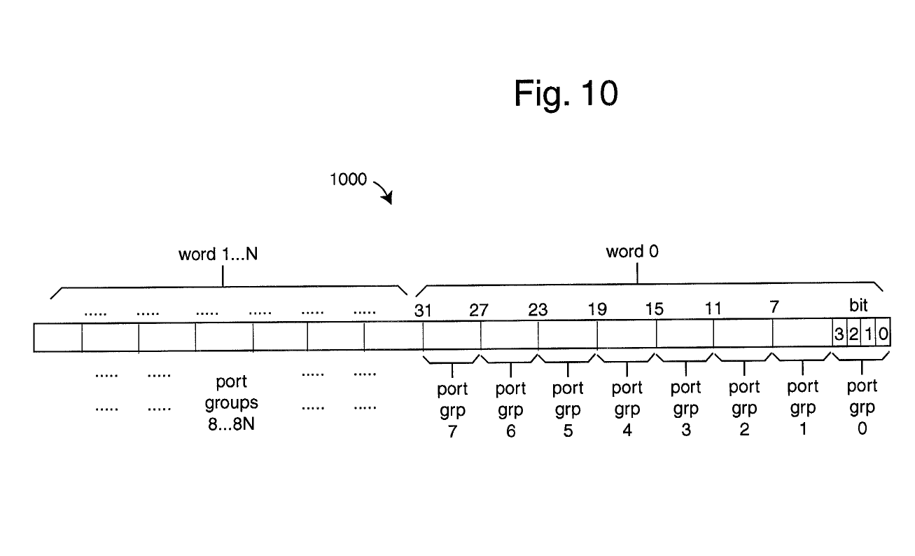

FIG. 10 represents a digital computer memory layout for a port-group table embodiment of the present invention, as is referred to herein by the general reference numeral 1000. Sixteen port groups are sufficient in the majority of applications, so only four bits of memory are needed to identity a port group number in this example. When thirty-two bit words are used, eight port group identifiers will fit in each word.

A TCP/UDP port number “n” can be mapped into a port group number very easily when the preferred memory organization of FIG. 10 is used. E.g., index=n MOD 8, or simply shift n to the right three bit positions. Also, if x=port group table (index), offset=n AND 7, and y=shift x to the right by (offset x4) bits. The port group number=y AND oxf.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A method for fetching bandwidth control information about a datapacket in a network that is associated with a port number carried within such datapacket, the method comprising the steps of:
parsing a port number from an information header in a datapacket;
searching for a matching port number in a port group table that associates port groups, port numbers, and service-level application policies; and
pointing to a particular service-level application policy if a match occurs in the step of searching.

2. The method of claim 1, further comprising the step of:
using said particular service-level application policy to control a communication bandwidth afforded to a communication throughput of said datapacket.

3. The method of claim 1, further comprising the preliminary step of:
listing a plurality of applications with standard port numbers as individual group entries in said port group table that are to be afforded communication bandwidth control; and
associating a plurality of service-level application policies with corresponding ones of said plurality of applications.

4. A network, comprising:
a local group of network workstations and clients with a set of corresponding local port numbers, and that periodically access a wide area network (WAN);
at least one type of application program for executing packet exchanges that involve any of the local group;
a class-based queue (CBQ) traffic shaper disposed between the local group and said WAN, and providing for a variety of access bandwidths;
a IP-address/port-number classifier (IP-address/port-number classifier) disposed within the CBQ traffic shaper, and providing for an identification of which application program transmitted or received a particular packet at any of the local group; and
an automatic bandwidth manager (ABM) disposed within the CBQ traffic shaper, and providing for a controlled delivery rate of each said particular packet that is dependent on the application-program type determined by the IP-address/port-number classifier;
wherein, bandwidth control information about a datapacket in the network is associated with a source or destination port number of such datapacket, and a processor provides for parsing a port number from an information header in a datapacket, and standard port numbers are gathered into groups that are used to point to individual service-level agreement (SLA) policies.

5. The network of claim 4, wherein:
the CBQ traffic shaper is configured such that a user SLA policy is attached to each and every said group.

6. The network of claim 4, wherein:
the CBQ traffic shaper is configured so any SLA policy conflicts between local port number transfers are resolved with a lower-speed one of said conflicting policies taking precedence.

7. The network of claim 4, wherein:
the CBQ traffic shaper dynamically attaches SLA policies and readjusts the CBQ traffic shaper to allow an on-demand type of delivery.

8. The network of claim 4, wherein:
the IP-address/port-number classifier monitors a particular port number and port for information that indicates that a particular application program is beginning a session;
the IP-address/port-number classifier uses said information to gather additional port number and port information that can be used to identify subsequent packet exchanges that belong to said particular application program; and
the ABM is provided with said information and said additional port number and port information for a class-base queue that favors packets from said particular application program with increased access bandwidth.

9. A computer network method, comprising the steps of:
dividing a plurality of datapackets into classes that include at least one class for packets exchanged over a computer network by a particular application program;
identifying which class each particular one of plurality of packets belongs to on said computer network;
controlling a delivery rate of an identified particular one of plurality of datapackets according to its classification;
parsing a port number from an information header in a datapacket;
searching for a matching port number in a port group table that associates port groups, port numbers, and service-level application policies; and
pointing to a particular service-level application policy if a match occurs in the step of searching.

10. The method of claim 9, wherein:
the step of identifying includes using a IP-address/port-number classifier (IP-address/port-number classifier) to monitor a particular port number and port for information that indicates that a particular application program is beginning a session, and said IP-address/port-number classifier uses said information to gather additional port number and port information that can be used to identify subsequent packet exchanges that belong to said particular application program; and
the step of controlling includes using an automatic bandwidth manager (ABM) that is provided with said information and said additional port number and port information, and uses a class-base queue that favors packets from said particular application program with increased access bandwidth.

11. The method of claim 10, wherein:
the step of dividing comprises classifying ones of the plurality of datapackets according to an adjustable parameter.

12. The method of claim 10, wherein:
the step of dividing comprises classifying ones of the plurality of datapackets depending on a dynamic variable.

13. The method of claim 10, wherein:
the step of identifying includes monitoring exchanges between a network client and a network server to extract a port information that is used in a subsequent data exchange; and
the step of classifying is such that the classifying depends on said port information.

14. The method of claim 10, wherein:
the step of controlling includes buffering ones of the plurality of datapackets.

15. The method of claim 10, wherein:
the step of controlling includes distributing ones of the plurality of datapackets amongst a corresponding plurality of class-based queues that are operated at rates that are dependent on said classes.

16. A computer network method, comprising the steps of:
dividing a plurality of datapackets into classes that include at least one class for packets exchanged over a computer network by a particular application program;
identifying which class each particular one of plurality of packets belongs to on said computer network with a IP-address/port-number classifier (IP-address/port-number classifier) that monitors a particular port number and port for information that indicates that a particular application program is beginning a session, and said IP-address/port-number classifier uses said information to gather additional port number and port information that can be used to identify subsequent packet exchanges that belong to said particular application program;
communicating any application-identifying information obtained in the step of identifying within a message to an automatic bandwidth manager (ABM); and
controlling with said ABM a delivery rate of an identified particular one of plurality of datapackets according to its classification;
wherein, bandwidth control information about a datapacket in the network is associated with a source or destination port number of such datapacket, and a processor provides for parsing a port number from an information header in a datapacket, and standard port numbers are gathered into groups that are used to point to individual service-level agreement (SLA) policies.
